(19) United States
(12) Patent Application Publication
(10) Pub. No.: US 2019/0182910 A1
(43) Pub. Date: Jun. 13, 2019

(54) Microwave spatial partition heating method in oven based on phased arrays technique

(71) Applicant: Sichuan University, Chengdu (CN)

(72) Inventors: Kama Huang, Chengdu (CN); Huacheng Zhu, Chengdu (CN); Yang Yang, Chengdu (CN); Xing Chen, Chengdu (CN); Changjun Liu, Chengdu (CN)

(73) Assignee: Sichuan University

(21) Appl. No.: 16/273,147

(22) Filed: Feb. 12, 2019

(30) Foreign Application Priority Data
Feb. 12, 2018 (CN) 201810147533.0

(51) Int. Cl. H05B 6/64; H05B 6/68; H05B 6/70; H05B 6/72

(52) U.S. Cl. CPC H05B 6/6447; H05B 6/72; H05B 6/70; H05B 6/68

(57) ABSTRACT

A microwave oven based on phased arrays includes a heating chamber; a microwave feed source, wherein the microwave feed source includes multiple array antennas which are evenly distributed at a top portion of the heating chamber; mass sensors which are adapted for at least dividing a bottom portion of the heating chamber into two parts; a phase control module for connecting the mass sensors and the array antennas, wherein the mass sensors are adapted for transmitting quality signals of an object to be heated to the phase control module. The quality signals of the object of the mass sensors are transmitted back to the phase control module, in which the microwave is radiated more to the food with high quality, that is, the space controllable heating is achieved, so as to improve energy efficiency and heating uniformity.

### CROSS REFERENCE OF RELATED APPLICATION

The present invention claims priority under 35U.S.C. 119(a-d) to CN 201810147533.0, filed Feb. 12, 2018.

### BACKGROUND OF THE PRESENT INVENTION

### Field of Invention

The present invention relates to the field of microwave heating, and more particularly to a microwave oven based on phased arrays and a spatial partition heating method thereof.

### Description of Related Arts

Currently, food-grade microwave heating chambers have been widely used in the market, such as domestic microwave ovens. All of these domestic microwave ovens use magnetrons as microwave sources. When the microwave radiation enters the chamber, the microwave field shows a standing wave distribution in the chamber. The foods with different qualities are put into the chamber for heating, and the foods with larger qualities are not necessarily located at the position where the microwave field is stronger, which is one of the main reasons for low energy efficiency and uneven heating.

It is urgent to provide a microwave heating system for effectively solving the above problem of uneven heating.

### SUMMARY OF THE PRESENT INVENTION

A microwave spatial partition heating method in oven based on phased arrays technique, provided by the present invention, solve the technical problem of uneven microwave heating in the prior art.

Technical solutions of the present invention are as follows. A microwave oven based on phased arrays comprises a heating chamber; a microwave feed source, wherein the microwave feed source comprises multiple array antennas which are evenly distributed at a top portion of the heating chamber; mass sensors which are adapted for at least dividing a bottom portion of the heating chamber into two parts; a phase control module for connecting the mass sensors and the array antennas, wherein the mass sensors are adapted for transmitting quality signals of an object to be heated to the phase control module.

Preferably, the phase control module comprises a signal processing unit for receiving quality and phase distribution signals transmitted by the mass sensors; a microwave feed system for controlling signal directions of the array antennas.

Preferably, there are four mass sensors all of which are distributed at the bottom portion of the heating chamber for inducing the quality distribution of the object in four areas.

Also, the present invention provides a spatial partition heating method of a microwave oven based on phased arrays, which comprises steps of:

(1) placing an object to be heated on a supporter located at a bottom portion of a heating chamber, wherein four mass sensors are disposed on the supporter;

(2) turning on a microwave switch; transmitting mass distribution signals of the object at regions where the four mass sensors are located to an intelligent module through the mass sensors, respectively; analyzing quality and phase distribution of the object, radiation time and beam scanning speed and direction of array antennas through the intelligent module; transmitting the beam scanning speed and direction to a microwave feed system through the intelligent module; and

(3) the microwave feed system controlling the array antennas according to information analyzed by the intelligent module in the step (2).

In the microwave oven based on phased arrays and the spatial distribution heating method thereof provided by the present invention, the quality signals of the object of the mass sensors are transmitted back to the phase control module, in which the microwave is radiated more to the food with high quality, that is, the space controllable heating is achieved, so as to improve energy efficiency and heating uniformity. Moreover, the intelligent microwave radiation is performed based on the quality and quality phase distribution of the object, so as to resolve the uneven problem in the prior art caused by the standing wave distribution of the microwave field in the heating chamber or fixed microwave field.

### BRIEF DESCRIPTION OF THE DRAWINGS

In order to more clearly explain the technical solutions in the embodiments of the present invention or the prior art, the drawings used in the description of the embodiments of the present invention or the prior art will be briefly described as below. Obviously, the drawings in the following description are only some embodiments of the present invention; for those skilled in the art, other drawings may also be obtained based on these drawings without any creative labor.

FIG. 1 is a spatial distribution structural diagram of a microwave oven based on phased arrays.

FIG. 2 is a flow chart of a spatial partition heating method of the microwave oven based on phased arrays.

FIG. 3 is a phase control diagram of an intelligent module of the microwave oven.

FIG. 4 is a heating temperature distribution diagram of a first quadrant microwave spatial partition.

FIG. 5 is a heating temperature distribution diagram of a second quadrant microwave spatial partition.

FIG. 6 is a heating temperature distribution diagram of a third quadrant microwave spatial partition.

FIG. 7 is a heating temperature distribution diagram of a fourth quadrant microwave spatial partition.

### DETAILED DESCRIPTION OF THE PREFERRED EMBODIMENT

The technical solutions in the embodiments of the present invention will be clearly and completely described with the accompanying drawings as follows. Apparently, the described embodiments are merely some but not all of the embodiments of the present invention. All other embodiments obtained by those skilled in the art based on the embodiments of the present invention without creative efforts shall fall within the protective scope of the present invention.

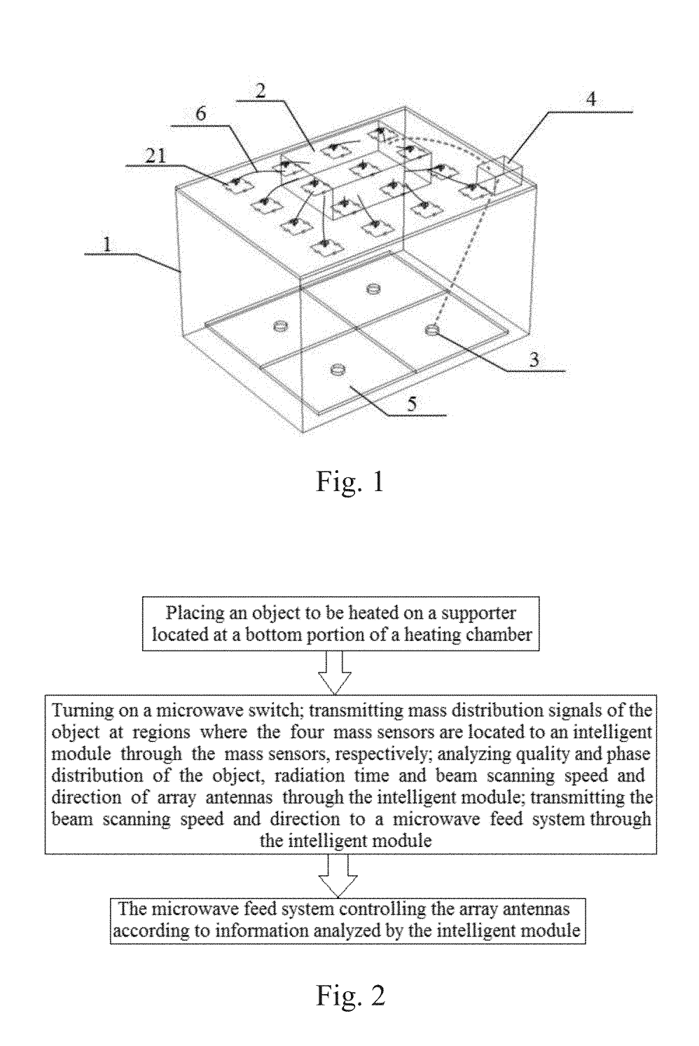

As shown in FIG. 1, a spatial distribution structural diagram of a microwave oven based on phased arrays is illustrated, which comprises a heating chamber 1, a microwave feed source 2, wherein the microwave feed source 2 comprises multiple array antennas 21 which are evenly distributed at a top portion of the heating chamber 1, mass sensors 3 which are adapted for at least dividing a bottom portion of the heating chamber 1 into two parts and are disposed below a supporter 5; a phase control module 4 for connecting the mass sensors 3 and the array antennas 21, wherein the mass sensors 3 are adapted for transmitting quality signals of an object to be heated to the phase control module 4. Due to the advantages of flexible beam pointing, simultaneous formation of multiple beams and good anti-interference performance, the phased array technology has been widely applied to the field of radar design.

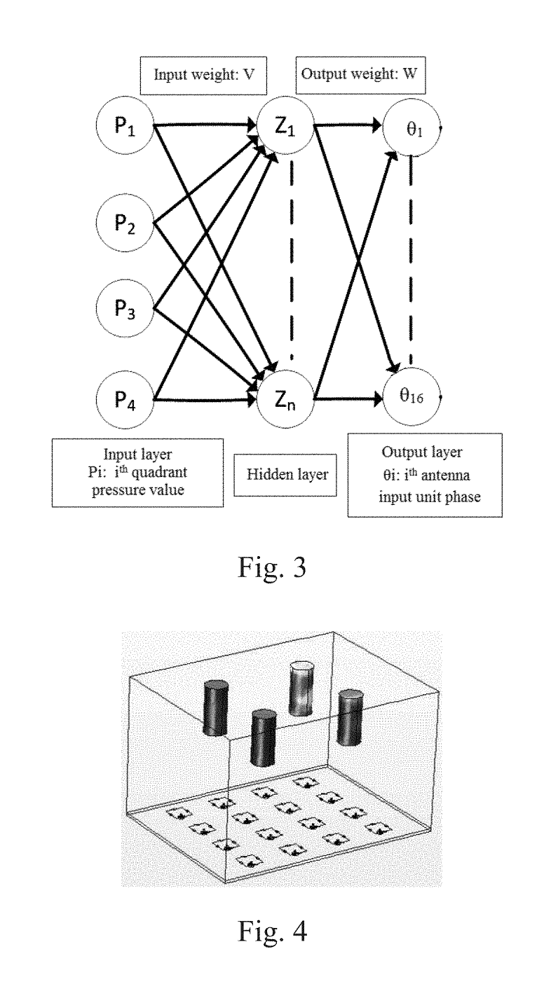

FIG. 3 is a phase control diagram. The phase control module 4 is adapted for receiving quality and phase distribution signals transmitted by the mass sensors 3, that is, P1, P2, P3 and P4 are respectively pressure values of a first quadrant, a second quadrant, a third quadrant and a fourth quadrant in Fig Through the artificial intelligence network, the phase information required by the array antennas 21 are obtained; through changing the input phase of the microwave feed source 2, the array antennas 21 are respectively performed feed via stationary phase cables 6 with a same length, so as to obtain beams pointing to different areas. The phase control module 4 further comprises a microwave feed system for controlling signal directions of the array antennas 21; the intelligent module for analyzing quality of an object to be heated, radiation time and beam scanning speed and direction of the array antennas 21. The signal processing unit is connected with the microwave feed system through the intelligent module.

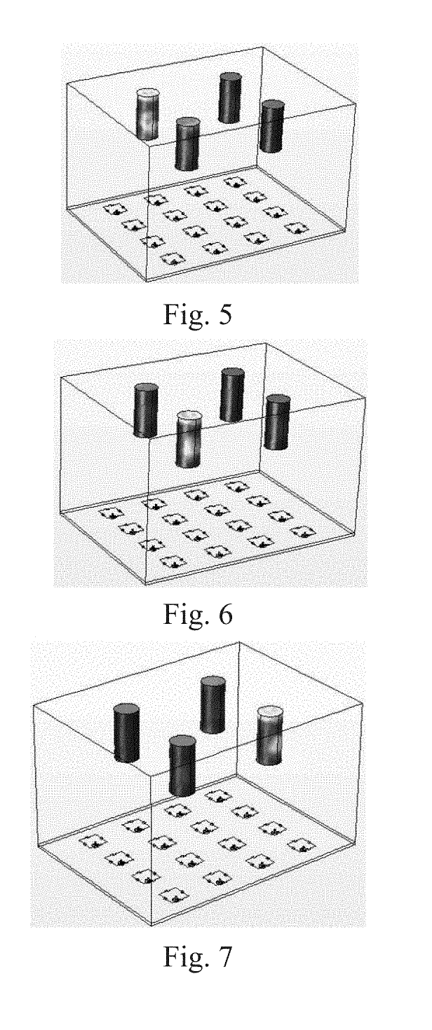

Preferably, there are four mass sensors 3 all of which are distributed at the bottom portion of the heating chamber 1 for inducing the quality distribution of the object in four areas. FIGS. 4 to 7 are heating temperature distribution diagrams of microwave spatial partitions and show the heating temperature distribution of the microwave spatial partitions when the beams respectively point to four different quadrants. It is found that after heating for 30 s, the temperature in the target area can be significantly increased, while the temperature changes in the other three areas are small, and the partition heating effect is obvious.

FIG. 2 is a flow chart of a spatial partition heating method of a microwave oven based on phased arrays, which comprises steps of:

(1) placing an object to be heated on a supporter located at a bottom portion of a heating chamber, wherein four mass sensors are disposed on the supporter;

(2) turning on a microwave switch; transmitting mass distribution signals of the object at regions where the four mass sensors are located to an intelligent module through the mass sensors, respectively; analyzing quality and phase distribution of the object, radiation time and beam scanning speed and direction of array antennas through the intelligent module; transmitting the beam scanning speed and direction to a microwave feed system through the intelligent module; and

(3) the microwave feed system controlling the array antennas according to information analyzed by the intelligent module in the step (2).

In the microwave oven based on phased arrays and the spatial distribution heating method thereof provided by the present invention, the quality signals of the object of the mass sensors are transmitted back to the phase control module, in which the microwave is radiated more to the food with high quality, that is, the space controllable heating is achieved, so as to improve energy efficiency and heating uniformity. Moreover, the intelligent microwave radiation is performed based on the quality and quality phase distribution of the object, so as to resolve the uneven problem in the prior art caused by the standing wave distribution of the microwave field in the heating chamber or fixed microwave field.

Of course, without departing from the spirit and essence of the present invention, those skilled in the art should be able to make various corresponding changes and modifications according to the present invention, but these corresponding changes and modifications should fall within the protection scope of the appended claims of the present invention.

What is claimed is:

1. A microwave oven based on phased arrays, which comprises a heating chamber; a microwave feed source, wherein the microwave feed source comprises multiple array antennas which are evenly distributed at a top portion of the heating chamber; mass sensors which are adapted for at least dividing a bottom portion of the heating chamber into two parts; a phase control module for connecting the mass sensors and the array antennas, wherein the mass sensors are adapted for transmitting quality signals of an object to be heated to the phase control module.

2. The microwave oven, as recited in claim 1, wherein the phase control module comprises a signal processing unit for receiving quality and phase distribution signals transmitted by the mass sensors; a microwave feed system for controlling signal directions of the array antennas.

3. The microwave oven, as recited in claim 1, wherein there are four mass sensors all of which are distributed at the bottom portion of the heating chamber for inducing the quality distribution of the object in four areas.

4. The microwave oven, as recited in claim 2, wherein there are four mass sensors all of which are distributed at the bottom portion of the heating chamber for inducing the quality distribution of the object in four areas.

5. A spatial partition heating method of a microwave oven based on phased arrays, which comprises steps of:
(1) placing an object to be heated on a supporter located at a bottom portion of a heating chamber, wherein four mass sensors are disposed on the supporter;
(2) turning on a microwave switch; transmitting mass distribution signals of the object at regions where the four mass sensors are located to an intelligent module through the mass sensors, respectively; analyzing quality and phase distribution of the object, radiation time and beam scanning speed and direction of array antennas through the intelligent module; transmitting the beam scanning speed and direction to a microwave feed system through the intelligent module; and
(3) the microwave feed system controlling the array antennas according to information analyzed by the intelligent module in the step (2).
